(19) United States
(12) Patent Application Publication
(10) Pub. No.: US 2005/0149382 A1
(43) Pub. Date: Jul. 7, 2005

(54) Method for administering a survey, collecting, analyzing and presenting customer satisfaction feedback

(76) Inventors: John D. Fenner, Tijeras, NM (US); Pete K. Rahn, Rio Rancho, NM (US)

Correspondence Address: John Fenner, 44 Woodlands Dr., Tijeras, NM, 87059, US

(21) Appl. No.: 11/019,138

(22) Filed: Dec. 22, 2004

Related U.S. Application Data
(60) Provisional application No. 60/531,990, filed on Dec. 24, 2003.

(51) Int. Cl. G06F 17/60

(52) U.S. Cl. 705/10; 705/11

(57) ABSTRACT

A customer interface device is programmed with one or more survey questions and information regarding the customer's satisfaction with a product or service provided at the location of such device. The customer interface device displays the question, the customer inputs his answer, and additional questions may be generated. The data is stored and periodically transmitted to a Base Control Unit such as a processor with modem or wireless components. The data is stored and periodically transmitted to a data analyzer such as a computer or server which analyzes the number of responses indicating customer satisfaction or dissatisfaction. If the number of one type of responses exceeds a specified threshold, then the business owner or service provider is notified immediately. If the number does not exceed the designated threshold, then the data analyzer manipulates the data for presentation, makes the data available to the subscribers and generates periodic user defined reports.

### CROSS-REFERENCE TO RELATED APPLICATIONS

This is a continuation of provisional patent application Ser. No. 60/531,990, filed Dec. 24, 2003.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

Monitoring of customer satisfaction of goods and services provided by businesses has become crucial in a global marketplace that is hyper-competitive. The importance of such information increases as a market segment matures. As competition increases customer experience becomes a major differentiator. The business that can identify sources of customer dissatisfaction, or limit that dissatisfaction in the first place, will have a better chance at succeeding in the market place. This is important because researchers have found that it costs up to five times as much to get a new customer as it does to retain an existing one. Additionally, a 5% increase in customer retention can translate into a 30% increase in earnings. In order to accomplish this, businesses must be able to efficiently measure customer satisfaction on a continuous, system-wide basis.

The fundamental problem of measuring customer satisfaction is the inverse correlation between customer response rates and cost to collect accurate data. In order to have a high response rate for customer usage, which increases the validity of the data, businesses have been faced with high cost options. Low cost options produce low response rates that have questionable validity and therefore are not useful for making operational decisions. Also, current systems tend to be used for recording dissatisfaction, but do not encourage continuous usage by repeat patrons to indicate when businesses are operating properly. Many systems are not contemporaneous which can distort the patron's assessment of satisfaction level at the time of the actual service.

However, recognition of the importance of customer satisfaction measurement has led many providers of goods and services to try to determine a level of customer satisfaction by a variety of methods. These methods all have the limitations outline above:
In person interviews
Comment cards
Mail in cards
Computer kiosk
Customer service desk
Toll free customer complaint lines
Employee interaction with customers
Focus groups
Mystery shoppers
Opinionmeter

Web based surveys

| | | | One-On-One | | Current Electronic |
|---|---|---|---|---|---|
| | Infotope | Card Response | Survey | Call-In Response | Devices |
| Ease of use | Very easy | Moderate to difficult | Easy | Difficult | Easy to moderate |
| Cost | Inexpensive | Very inexpensive | Extremely expensive | Moderate | Very expensive |
| Response rate | Very high | Very low | High | Very low | Low |
| Depth of knowledge | Low | Low | High | Moderate | Moderate |
| Frequency of use | Constant | Infrequent | Very infrequent | Infrequent | Constant to frequent |
| Time to respond | Extremely little | Moderate | Extensive | Moderate | Moderate |
| Understandable | Very easy | Easy | Difficult | Moderate | Moderate |
| analysis | | | | | |

Therefore, a simple, inexpensive, easy to use, non-intrusive device is needed to allow business owners and service providers the opportunity to obtain anonymous, accurate, contemporaneous, inexpensive customer satisfaction information along with an interactive analysis procedure that will allow the service provider to readily access and understand performance, trend and comparative data collected real time system-wide with virtually no effort by his staff. This invention is meant to satisfy that need.

Patents that have been granted that are similar but fail to capture all the features of this invention are:
U.S. Pat. No. 5,038,367 to Casey is a simple device for very basic surveying. It is stationary and is intended to be placed in the lobby of a bank, or similar location, to survey customers. A single question is presented on a printed placard, and the customer is given the option of answering “yes” or “no” via two buttons on the face of the device. It is essentially a counter of responses. There is no time of day/day of week data, no analysis of data, no ability to remotely change question, no remote access or collection of data, which limits its usefulness to the service provider.

U.S. Pat. No. 4,345,315 to Cadotte et al presents a more flexible survey device than the Casey device in that it can present several questions and accept three or more alternative answers to each question. This very feature complicates the response system for the responder and will result in fewer responses, particularly repeat patrons. The answers are presented on written labels that are inserted into the device in alignment with the response keys. This unit must be manually programmed for pressure sensitive/multi option keyboard, with a portable memory for collection and download manually. It is very intimidating to the consumer and its size limits the service provider's ability to place the device.

U.S. Pat. No. 6,093,026 to Walker et al presents a method whereby a computer generates questions to transmit over the Internet to existing customer lists with the purpose of verifying customer consistency and verification of consistent answers as opposed to on-site. It is not gathering on-site samples at time of service and is not anonymous for the consumer.

U.S. Pat. No. 5,822,744 to Kesel is voice driven and collects verbal comments on products and services. It focuses on specific customer thoughts instead of overall “satisfaction”. It requires a person to listen and categorize the responses and enter the data into a predetermined program structure. The customer has to enter the bar code number of the product he wishes to comment on, which will further limit the number of customers responding.

U.S. Pat. No. 5,535,118 to Chambly is for a data collection device (card reader) using data cards inserted by customer. Device prints coupon as reward for providing survey data. It is very cumbersome and relatively difficult and time consuming for customers to use.

U.S. Pat. No. 5,812,647 to Beaumont et al is a marketing program that allows customers the option of selecting the marketing topic they want. It does not involve measuring satisfaction levels. It is more interactive than other inventions requiring TV type screens which allows customers to enter numerous responses depending on depth of interview. Device is telephone based with a screen that has a message that can be remotely changed and programmed to ask additional questions. It can also allow customer to directly call and interact with the direct marketing company. Also there is no analysis of data other than tracking the number of responses.

U.S. Pat. No. 6,380,928 to Todd is aimed at alerting a service provider after a customer has responded to a series of questions and would allow the provider to interact with the customer before the customer leaves the premises. No in-depth analysis of responses as a whole is provided to the service provider.

U.S. Pat. No. 6,549,890 to Mundell et al is a system for businesses to collate customer responses received via fax/email/phone/letters regarding customer satisfaction and manually enter data themselves.

U.S. Pat. No. 6,574,614 to Kesel deals with collecting oral responses from customers but does not specifically ask customers about overall satisfaction. This adaptation is more complicated for the consumer as well as the service provider.

U.S. Pat. No. 6,810,343 to McKee is a system to monitor on site interaction of restaurant staff with patrons. It measures arrival time/staff contact time/delivery of food time/etc. creates a level of service measurement . . . not a satisfaction measurement.

In summary it would, therefore, be advantageous to provide an interactive, self-administered survey device, which is easy to use, which is not perceived by survey respondents as tedious but provides up-to-date information to the service provider from a large sample of customers with no effort on the part of the service provider.

Fields of Search 235/37,375,381: 345/169: 364/401: 377/13: 379/10.03, 67: 399/8: 434/322: 455/423: 702/81: 705/10: 706/52: 707/4: 709/203:

References Cited [Referenced By]
U.S. Patent Documents

| | | | |
|---|---|---|---|
| 4345315 | August, 1982 | Cadotte et al | 705/10 |
| 5038367 | August, 1991 | Casey et al | 377/13 |
| 5041972 | August, 1991 | Frost | 364/401. |
| 5077785 | December, 1991 | Monson | 379/67. |
| 5237157 | August, 1993 | Kaplan | 235/375 |
| 5315093 | May., 1994 | Stewart | 235/381. |
| 5392095 | February, 1995 | Siegel | 399/8 |
| 5535118 | July 1996 | Chambly | 235/37 |
| 5822744 | October, 1998 | Kesel | 706/52. |
| 5940471 | August, 1999 | Homayoum | 379/10.03 |
| 6026387 | February, 2000 | Kesel | 706/52. |
| 6093026 | July 2000 | Walker et al | 434/322 |
| 6243738 | June 2001 | Hayes et al | 709/203 |
| 6380928 | April 2002 | Todd | 345/169 |
| 6445916 | Sept., 2002 | Bahman | 455/423 |
| 6549890 | April 2003 | Murdall et al | 705/10 |
| 6574614 | June 2003 | Kesel | 706/52 |
| 6574621 | June 2003 | Lautzenheiser et al | 707/4 |
| 6616458 | Sept., 2003 | Walker, et al | 434/322 |
| 6810343 | December, 2000 | McKee | 702/81 |

US2002/0194072 A1
PCT WO 99/34274

### BRIEF SUMMARY OF THE INVENTION

The device consists of a housing holding two buttons and a message screen whose message can be changed remotely. Questions may be changed at the direction of the business owner. The device is fixed to a location (or locations) within the place of business. Connected to the housing is a power cord or battery and a connection to an input/output analyzer that will collect the data as the customer enters responses. Each entry has a time/date stamp. Each location may have multiple devices and the analyzer differentiates between devices so it is able to record customer satisfaction at different locations within the same site. During non-peak times the analyzer daily downloads, via hard phone line, wireless or cell phone communication, the information, including the linked time and location data to a central location for in-depth analysis and posting to a web site.

Once the data is analyzed, periodic reports are furnished to the business showing location responses received from, time of day, day of week of response, percent and number of satisfied/dissatisfied responses, trends and comparisons of locations. Emergency notifications are sent to owners if an abnormal rate of dissatisfied responses is obtained. Owners also have continuous access to their information via a web site.

### BRIEF DESCRIPTION OF THE SEVERAL VIEWS OF THE DRAWING

These and other features, aspects, and advantages of the present invention will become better understood with regard to the following description and accompanying drawings where:

FIG. 1 is a perspective view of the Customer Interface Device;

FIG. 2 is a schematic illustration of an apparatus for administering a survey, >collecting, analyzing and presenting customer satisfaction feedback;

FIG. 3 is a flow chart illustrating a first method for administering a survey, collecting, analyzing and presenting customer satisfaction feedback;

FIG. 4 is a flow chart illustrating a second method for administering a survey, collecting, analyzing and presenting customer satisfaction feedback;

FIG. 5 is a flow chart illustrating a third method for administering a survey, collecting, analyzing and presenting customer satisfaction feedback.

### DETAILED DESCRIPTION

The following definitions apply to this disclosure:

Customer Interface Device or CID is a device that is capable of displaying survey questions, collecting data, associating parameters such as time and location, initiating follow-up questions, having its programming remotely changed, storing and transmitting collected data as well as a status of the CID's condition to a Base Control Unit, and communicating with the Base Control Unit. In one embodiment of the present invention, the CID is capable of random coupon distribution. According to another embodiment, the CID is capable of identifying a survey respondent by a code, such as a bar code, with a means such as a bar code scanner. According to another embodiment, the CID has a means to draw the respondent's attention, such as a flashing light.

Base Control Unit or BCU is a device that is capable of receiving data transmitted from the Customer Interface Device, associating parameters such as a date, storing collected data, transmitting such data to the Data Analyzer, communicating with the Customer Interface Device and Data Analyzer, and checking the status of the Customer Interface Device.

Data Analyzer is a device that is capable of storing, analyzing, manipulating and transmitting data, communicating with the Base Control Unit, Access Portal and Notification Module, and generating user defined reports.

Notification Module is a device that is capable of receiving communications from the Data Analyzer and notifying the business owner or service provider that the customer satisfaction or dissatisfaction response level has reached a specified threshold.

Access Portal is a device that is capable of communicating with the Data Analyzer, providing the business owners or service providers access to the customer satisfaction or dissatisfaction data and periodic reports, and providing the business owners or service providers access to the Customer Interface Device for the purpose of programming questions or information.

Now, referring to the drawings, the method for administering a survey, collecting, analyzing and presenting customer satisfaction feedback will be described in detail.

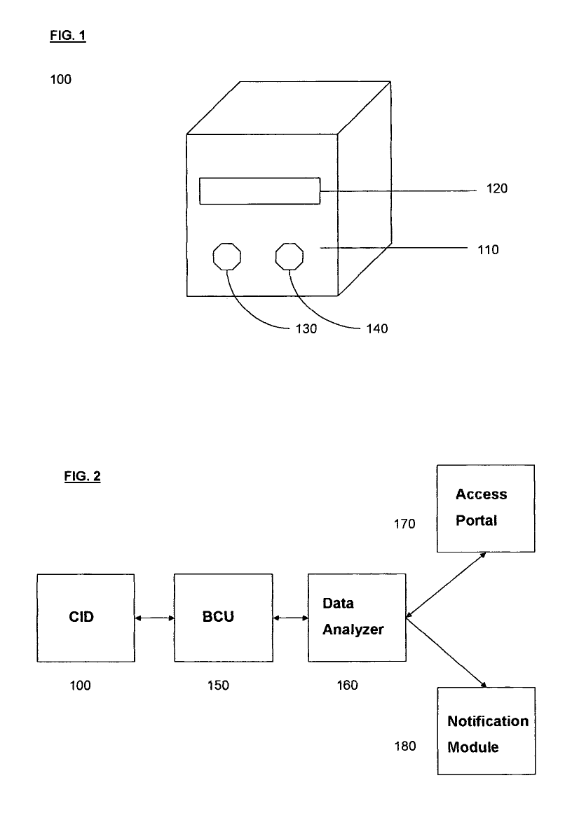

Referring to FIG. 1, the CID 100 is illustrated with the front face of the housing 110. Mounted to the front face of the housing 110 is a variable message screen 120 that allows for a survey question or other information to be displayed to the customer. Also mounted to the front face of the housing 110 are two customer response input push buttons 130 and 140 that may be labeled at the discretion of the business owner or service provider. In one embodiment, customer response input push button 130 may be labeled with a “yes” and customer response input push button 140 may be labeled with a “no”. In an alternate embodiment, the input push button 130 may be labeled with an “A” and customer response input push button 140 may be labeled with a “B”. According to another embodiment of the present invention, a light with flashing capabilities may be affixed to the top. In an alternate embodiment, the CID 100 may have a means for random coupon distribution affixed to it.

According to yet another embodiment the CID 100 may also have affixed a means to scan bar codes on receipts for the purpose of identifying customer responses.

Now referring to FIG. 2, a schematic illustration of the apparatus for administering a survey, collecting, analyzing and presenting customer satisfaction feedback is shown. The CID 100 is placed at one or more locations where the customer has purchased or consumed the product or service. Although one CID 100 is shown in FIG. 2, multiple CIDs may be present at one establishment. The information collected by the CID 100 is stored, parameters may be associated, and the information is periodically transmitted to the BCU 150 in such a manner as via a wire or wireless link. The BCU 150 may be a device such as a processor with modem or wireless components. The BCU 150 associates parameters with the data, stores the data, and then periodically transmits the data to a Data Analyzer 160 in such a manner as via a wire or wireless link. The BCU 150 will also communicate with the CID 100 to check the status of the CID 100. The Data Analyzer 160 may be a device such as a computer or server. The Data Analyzer 160 stores, analyzes and manipulates the data for access by and transmission to a business owner or service provider. The Data Analyzer 160 is capable of either communicating with the BCU 150 or making the data available to a business owner or service provider in at least one of two ways. One, if the level of responses indicating customer satisfaction or dissatisfaction with the product or service reaches a specified threshold level, the Data Analyzer 160 transmits a notice to a Notification Module 180 in such a manner as via a wire or wireless link. The Notification Module 180 may include such devices as a telephone, facsimile, pager, e-mail, the Internet, or the Data Analyzer 160 of FIG. 2. The Notification Module 180 will then notify the business owner or service provider that the customer satisfaction or dissatisfaction response level has reached the specified threshold. Two, the Data Analyzer 160 periodically transmits the data to an Access Portal 170 in such a manner as via a wire or wireless link. The Access Portal 170 may be an object such as a website, cellular phone or personal digital assistant designed to permit the business owner or service provider access to the data when the business owner or service provider so wishes. The business owner or service provider may also access the Data Analyzer 160 through the Access Portal 170 to reprogram the survey questions asked by the CID 100.

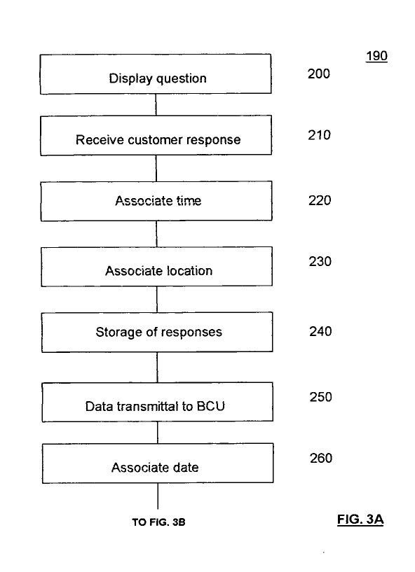

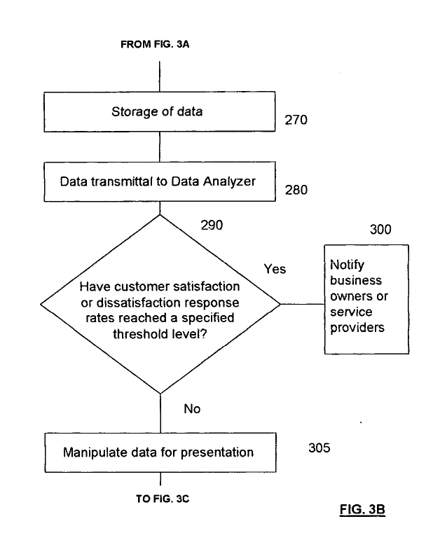

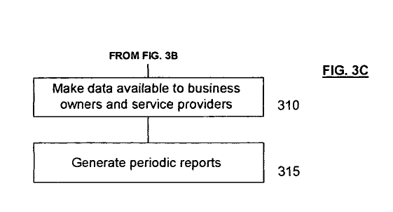

Now referring to FIG. 3, a method 190 is performed by the CID 100 of FIG. 1 generating one survey question or other information. In particular, the CID 100 of FIG. 1 displays a question on the variable message screen 120 of FIG. 1 regarding the customer's satisfaction with the particular product or service purchased or consumed at the place of business or service where the CID 100 of FIG. 1 is located (step 200). The CID 100 of FIG. 1 receives the response from the customer by the customer pushing the appropriate customer response input push button 130 or 140 of FIG. 1 (step 210). The CID 100 of FIG. 1 associates a time (step 220), associates a location (step230), stores the responses (step240) and periodically transmits the data to the BCU 150 of FIG. 2 in such a manner as via a wire or wireless link (step 250). The BCU 150 of FIG. 2 associates a date (step 260) with the data and stores the data (step 270).

The BCU 150 of FIG. 2 periodically transmits the data to the Data Analyzer 160 of FIG. 2 in such a manner as via a wire or wireless link (step 280). The Data Analyzer 160 of FIG. 2 analyzes the number of responses indicating customer satisfaction or dissatisfaction (step 290). If the level of responses indicating customer satisfaction or dissatisfaction with the product or service reaches a specified threshold level, then the business owner or service provider is notified by the Notification Module 180 of FIG. 2 (step 300).

If the level of responses indicating customer satisfaction or dissatisfaction with the product or service does not exceed the specified threshold level, then the Data Analyzer 160 of FIG. 2 manipulates the data for presentation (step 305) and makes the data available for access by the business owner or service provider through the Access Portal 170 of FIG. 2 (step 310). In addition, the Data Analyzer 160 of FIG. 2 will generate periodic reports (step 315). These periodic reports may be used to correlate customer satisfaction to other activities that are ongoing where the CID 100 of FIG. 2 is located, for example.

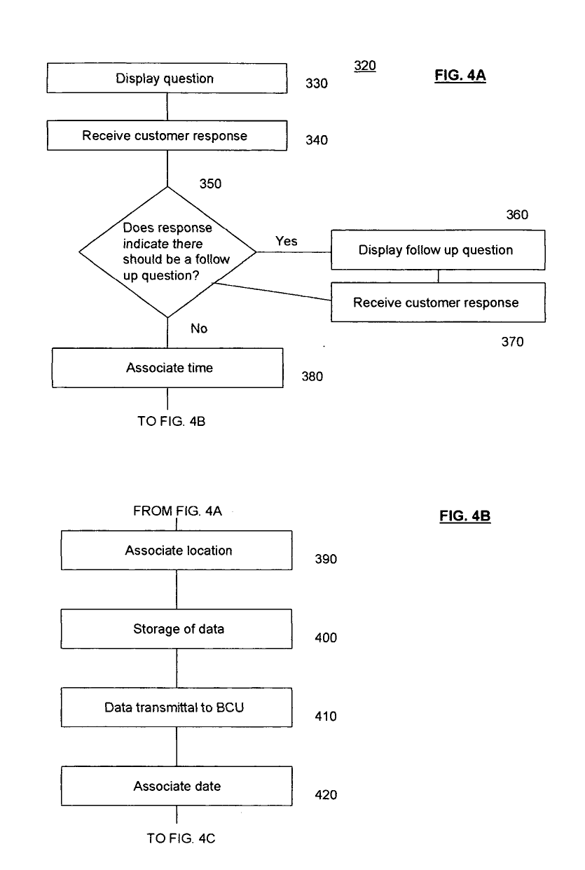

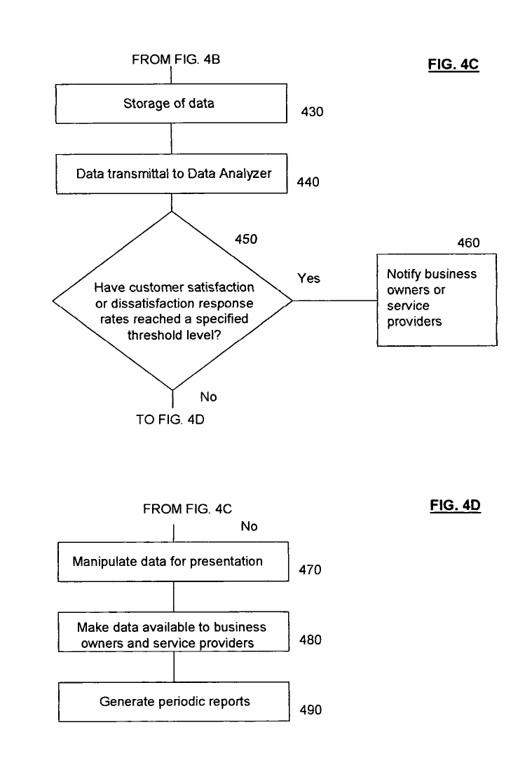

Now referring to FIG. 4, an alternative method 320 is performed by the CID 100 of FIG. 1 generating multiple survey questions or other information. The method 320 is performed by the CID 100 of FIG. 1 displaying a question on the variable message screen 120 of FIG. 1 regarding the customer's satisfaction with the particular product or service purchased or consumed at the place of business or service where the CID 100 of FIG. 1 is located (step 330). The CID 100 of FIG. 1 receives the response from the customer by the customer pushing the appropriate customer response input push button 130 or 140 of FIG. 1 (step 340). The CID 100 of FIG. 1 analyzes the response to determine if the response is such that there should be a follow up question (step 350). If a follow up question is so indicated, then the follow up question is generated and displayed on the variable message screen 120 of FIG. 1 (step 360). The CID 100 of FIG. 1 receives the response from the customer to the follow up question by the customer pushing the appropriate customer response input push buttons 130 or 140 of FIG. 1 (step 370). The business owner or service provider will have the discretion to pre-determine the number of follow up questions. This process will repeat itself until the CID 100 of FIG. 1 is without any further follow up questions. The CID 100 of FIG. 1 then associates a time (step 380), associates a location (step 390), stores the data (step 400) and periodically transmits the data gathered from either the single question if no follow up question was indicated, or from the initial question and the follow up questions to the BCU 150 of FIG. 2 in such a manner as via a wire or wireless link (step 410). The BCU 150 of FIG. 2 associates a date (step 420) with the data and stores the data (step 430).

The BCU 150 of FIG. 2 periodically transmits the data to the Data Analyzer 160 of FIG. 2 in such a manner as via a wire or wireless link (step 440). The Data Analyzer 160 of FIG. 2 analyzes the number of responses indicating customer satisfaction or dissatisfaction (step 450). If the level of responses indicating customer satisfaction or dissatisfaction with the product or service reaches a specified threshold level, then the business owners or service providers are notified by the Notification Module 180 of FIG. 2 (step 460).

If the level of responses indicating customer satisfaction or dissatisfaction with the product or service does not exceed the specified threshold level, then the Data Analyzer 160 of FIG. 2 manipulates the data for presentation (step 470) and makes the data available for access by the business owner or service provider through the Access Portal 170 of FIG. 2 (step 480). In addition, the Data Analyzer 160 of FIG. 2 will generate periodic user defined reports (step 490). These periodic reports may be used to correlate customer satisfaction to other activities that are ongoing where the CID 100 of FIG. 2 is located, for example.

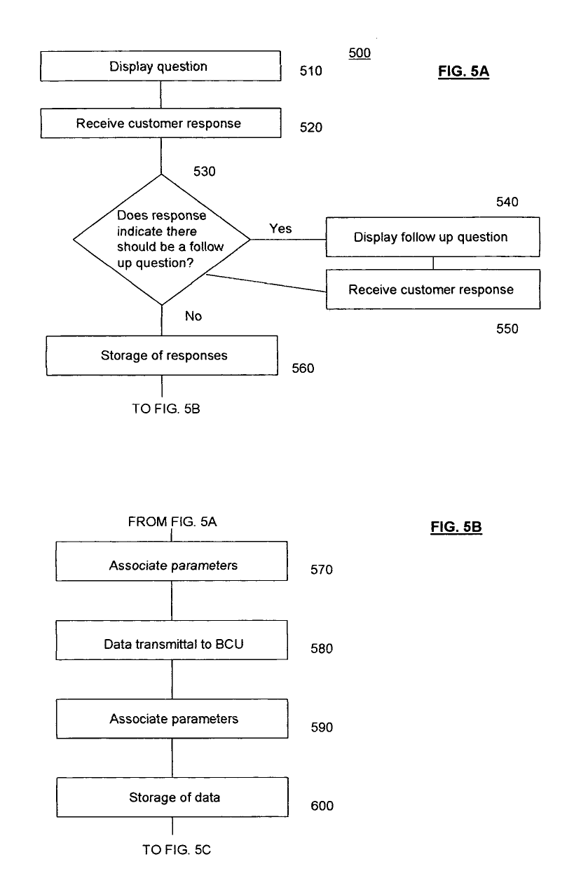

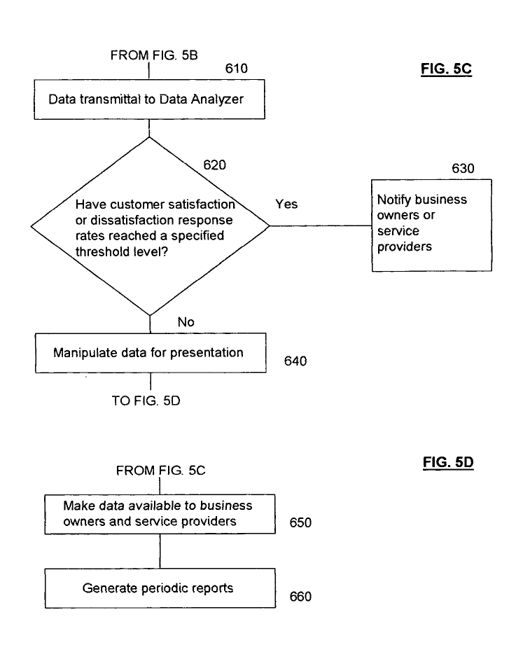

Now referring to FIG. 5, an alternative method 500 is performed by the CID 100 of FIG. 1 generating multiple survey questions or other information. The method 500 is performed by the CID 100 of FIG. 1 displaying a question on the variable message screen 120 of FIG. 1 regarding the customer's satisfaction with the particular product or service purchased or consumed at the place of business or service where the CID 100 of FIG. 1 is located (step 510). The CID 100 of FIG. 1 receives the response from the customer by the customer pushing the appropriate customer response input push button 130 or 140 of FIG. 1 (step 520). The CID 100 of FIG. 1 analyzes the response to determine if the response is such that there should be a follow up question (step 530). If a follow up question is so indicated, then the follow up question is generated and displayed on the variable message screen 120 of FIG. 1 (step 540). The CID 100 of FIG. 1 receives the response from the customer to the follow up question by the customer pushing the appropriate customer response input push buttons 130 or 140 of FIG. 1 (step 550). The business owner or service provider will have the discretion to predetermine the number of follow up questions. This process will repeat itself until the CID 100 of FIG. 1 is without any further follow up questions. The CID 100 of FIG. 1 the stores the responses (step 560), associates various parameters such as time (step 570) and periodically transmits the data gathered from either the single question if no follow up question was indicated, or from the initial question and the follow up questions to the BCU 150 of FIG. 2 in such a manner as via a wire or wireless link (step 580). The BCU 150 of FIG. 2 associates parameters such as time, location or product (step 590) with the data and stores the data (step 600).

The BCU 150 of FIG. 2 periodically transmits the data to the Data Analyzer 160 of FIG. 2 in such a manner as via a wire or wireless link (step 610). The Data Analyzer 160 of FIG. 2 analyzes the number of responses indicating customer satisfaction or dissatisfaction (step 620). If the level of responses indicating customer satisfaction or dissatisfaction with the product or service reaches a specified threshold level, then the business owner or service provider is notified by the Notification Module 180 of FIG. 2 (step 630).

If the level of responses indicating customer satisfaction or dissatisfaction with the product or service does not exceed the specified threshold level, then the Data Analyzer 160 of FIG. 2 manipulates the data for presentation (step 640) and makes the data available for access by the business owner or service provider through the Access Portal 170 of FIG. 2 (step 650).

In addition, the Data Analyzer 160 of FIG. 2 will generate periodic user defined reports (step 660). These periodic reports may be used to correlate customer satisfaction to other activities that are ongoing where the CID 100 of FIG. 2 is located, for example.

### DETAILED DESCRIPTION OF THE INVENTION

A consumer opinion and feed back device and server based system for collecting, analyzing and reporting contemporaneous customer satisfaction with a service or product provider, comprising of a simple, two option (Yes/No or More/Less) information collection device with a remotely changeable message screen, coupled with a data storage device, a data transmitter for transmitting data to a remote site for analysis and computer programming for easy analysis by either the service or device provider.

The device has two buttons and a message screen located on the front of said device that allows the customer to push one button or the other indicating whether the customer agreed or disagreed with the question/comment on the message screen.

The data storage device has time of day and date information to correlate with the customer entry to allow time sensitive data analysis thus allowing the service provider to correlate satisfied/dissatisfied customer to other activities ongoing at the location of the feed back device.

This invention relates to a device and related equipment that allows for the simplification of collecting customer's level of satisfaction with a business' level of service.

Several devices have been patented that try to capture customer feedback in a non-intrusive low cost way. However, this invention differentiates from those in several important aspects. First, no current invention correlates all of the following features: ease of use by both customer and client business, low cost and high response rate. Second, no other device is as unobtrusive to the actual business taking place in the client's place of business. Third, the customer interface devices can be utilized by customers in less than 1.5 seconds allowing the customer to registered their overall satisfaction of the performance of the business being patronized quickly thereby insuring very high response rates.

1. A system for automated, remote acquisition and collection of customer satisfaction feedback simultaneously from multiple locations, analyzing this feedback and presenting it to provide critical operational performance information through the utilization of a server based method that is scalable and low cost, the system comprising:
a) a uniquely identifiable electronic customer interface device with alphanumeric-graphic-capable display to present a question(s) to customers with two oversized buttons for entering their response and
b) a uniquely identifiable base control unit that periodically transfers questions to customer interface devices along with time synchronization, hours for their operation, new graphics and receives from the customer interface devices their operating condition and customer responses to store until a programmed time it will contact the server.
which are the means for administering an anonymous customer satisfaction survey at multiple customer interface points simultaneously to provide subunit as well as divisional operational performance information;
a) multiple locations means numerous sites at a single business establishment and/or
b) multiple business establishments
means for acquiring, collecting, analyzing and presenting the data without intercession by business establishment staff through remote, automated management of the system;
means for translating the customer satisfaction data to a predetermined format in a database;
means for correlating stored data with time; date; location; and operating unit to establish performance results including trends and comparisons
a) correlating customer responses by time of day, day of week, location of customer interface device (e.g., drive-up window, restroom, exit door #3 or customer service window #2) and/or unit regardless of size (e.g., afternoon shift, manager X, store #152, region #7, subsidiary unit, entire company or industry),
b) correlating customer response trends including those by denomination cited in a) above
c) correlating customer response results by relative and comparative analysis including those by denomination cited in a) above
means for regular and extraordinary notification of customer satisfaction performance to desired persons/units;
means for business owner/operator (or their designees) to access standard and custom reports generated by the system;

2) Claims made in 1) above are possible due to the utilization of an internet centered method for management of base control units/customer interface devices and for the distribution of data analysis to client business owner/operators
which is the means to have an unlimited number of base control units/customer interface devices to provide vast amounts of customer input to populate data bases to analyze contemporaneous customer satisfaction levels by multiple units within an operation.
Other objects, features and advantages of the present invention will become apparent to those skilled in the art from the following detailed description. It should be understood, however, that the detailed description and specific examples, while indicating preferred embodiments of the present invention, are given for purposes of illustration and not of limitation. Many changes and modifications within the scope of the present invention may be made without departing from the spirit thereof, and the invention includes all such modifications.
